(19) United States
(12) Patent Application Publication
(10) Pub. No.: US 2026/0204200 A1
(43) Pub. Date: Jul. 16, 2026

(54) DISPLAY PANEL AND DISPLAY DEVICE

(71) Applicant: Xiamen Tianma Microelectronics Co., Ltd., Xiamen (CN)

(72) Inventors: Shanshan WANG, Xiamen (CN); Zhenhai YIN, Xiamen (CN); Ronghua LI, Xiamen (CN); Xiongping LI, Xiamen (CN)

(73) Assignee: Xiamen Tianma Microelectronics Co., Ltd., Xiamen (CN)

(21) Appl. No.: 19/230,008

(22) Filed: Jun. 5, 2025

(30) Foreign Application Priority Data
Dec. 13, 2024 (CN) 202411844327.7

(51) Int. Cl. G09G 3/20; G09G 3/3233

(52) U.S. Cl. CPC G09G 3/2074; G09G 3/2014; G09G 3/3233; G09G 2300/0452; G09G 2300/0804; G09G 2300/0819; G09G 2300/0852; G09G 2310/06; G09G 2310/08; G09G 2320/0233; G09G 2320/0242

(57) ABSTRACT

Embodiments of the present application provides a display panel and a display device. The display panel comprises a sub-pixel group comprising n driving circuits and m light-emitting elements, output ends of the n driving circuits being electrically connected to the m light-emitting elements; the m light-emitting elements comprise n first light-emitting elements and i second light-emitting elements, output ends of the n driving circuits being electrically connected to the n first light-emitting elements, an output end of at least one driving circuit being electrically connected to the i second light-emitting elements via interpolation units, the i second light-emitting elements being electrically connected to compensation units, n+i=m, m, n, i are all integers greater than 0; the interpolation unit is configured to transmit a driving signal from the driving circuit to the second light-emitting element, the compensation unit is configured to compensate the driving signal to the second light-emitting element.

### CROSS-REFERENCE TO RELATED APPLICATION

The present application claims priority to Chinese Patent Application No. 202411844327.7 filed on Dec. 13, 2024, and titled “DISPLAY PANEL AND DISPLAY DEVICE”, which is incorporated herein by reference in its entirety.

### TECHNICAL FIELD

The present application relates to the technical field of display technology, and in particular to a display panel and a display device.

### BACKGROUND

With the development of display technology, the application of display panels is becoming more common, and users have more requirements for display panels. In order to meet the requirements of higher definition, the resolution of display panels is getting higher and higher.

When the demand for ultra-high resolution is needed, it is necessary to increase the number of pixel arrays; this means that a larger display panel is required. However, for a display panel of a constant size, there is limited space for expanding the pixel array, and the display resolution level cannot be further increased. How to increase the display resolution level without increasing the size of the display panel is a difficult problem faced by those skilled in the art.

### SUMMARY

Embodiments of the present application provide a display panel and a display device, which can increase the display resolution level without increasing the size of the display panel.

In a first aspect, embodiments of the present application provide a display panel, comprising a sub-pixel group, the sub-pixel group comprising n driving circuits and m light-emitting elements, output ends of the n driving circuits are electrically connected to the m light-emitting elements; the m light-emitting elements comprising n first light-emitting elements and i second light-emitting elements, the output ends of the n driving circuits are electrically connected to the n first light-emitting elements in a one-to-one correspondence, and the output end of at least one driving circuit is electrically connected to the second light-emitting element via interpolation units, the second light-emitting elements are electrically connected to compensation units, where n+i=m, and m, n, i are all integers greater than 0, the interpolation unit is configured to transmit a driving signal from the driving circuit to the second light-emitting element, and the compensation unit is configured to compensate the driving signal to the second light-emitting element.

In a second aspect, embodiments of the present application provides a display device, comprising a display panel according to embodiments of the first aspect.

According to the display panel and the display device provided in the embodiments of the present application, n driving circuits are configured to drive m light-emitting elements, where n is less than m, thereby reducing the number of driving circuits and enabling more light-emitting elements to be arranged in a limited space, thereby improving the display resolution of the display panel; in addition, the compensation unit is configured to compensate the driving signal to the second light-emitting element, and the driving signal obtained by the interpolation unit from the driving circuit and the compensation signal provided in the compensation unit jointly drive the second light-emitting element to meet the brightness requirement of the second light-emitting element, thereby improving the display resolution while ensuring the normal light-emitting ability of the light-emitting element.

### BRIEF DESCRIPTION OF THE DRAWINGS

Other features, objects and advantages of the present application will become more apparent by reading the following detailed description of non-limiting embodiments with reference to the accompanying drawings, in which the same or similar reference numerals represent the same or similar features and the accompanying drawings are not drawn to scale.

FIG. 1 is a schematic structural diagram of a display panel provided in an embodiment of the present application;

FIG. 2 is a schematic structural diagram of a sub-pixel group in a display panel provided in an embodiment of the present application;

FIG. 3 is a schematic structural diagram of another sub-pixel group in a display panel provided in an embodiment of the present application;

FIG. 4 is a schematic structural diagram of another sub-pixel group in a display panel provided in an embodiment of the present application;

FIG. 5 is a schematic structural diagram of another sub-pixel group in a display panel provided in an embodiment of the present application;

FIG. 6 is a schematic structural diagram of another sub-pixel group in a display panel provided in an embodiment of the present application;

FIG. 7 is a schematic circuit structural diagram of a sub-pixel group in a display panel provided in an embodiment of the present application;

FIG. 8 shows a timing diagram of FIG. 7;

FIG. 9 is a schematic circuit structural diagram of another sub-pixel group in a display panel provided in an embodiment of the present application;

FIG. 10 is a schematic circuit structural diagram of another sub-pixel group in a display panel provided in an embodiment of the present application;

FIG. 11 is a timing diagram of FIG. 10;

FIG. 12 is a schematic circuit structural diagram of another sub-pixel group in a display panel provided in an embodiment of the present application;

FIG. 13 is a schematic circuit structural diagram of another sub-pixel group in a display panel provided in an embodiment of the present application;

FIG. 14 is another schematic circuit structural diagram of a driving circuit provided in an embodiment of the present application;

FIG. 15 is another schematic circuit structural diagram of a driving circuit provided in an embodiment of the present application;

FIG. 16 is a schematic circuit structural diagram of another sub-pixel group in a display panel provided in an embodiment of the present application;

FIG. 17 is a timing diagram showing FIG. 16;

FIG. 18 is a schematic diagram showing a top view of a sub-pixel group in a display panel provided in an embodiment of the present application;

FIG. 19 is a schematic structural diagram showing a top view of another sub-pixel group in a display panel provided in an embodiment of the present application;

FIG. 20 is a schematic structural diagram showing a top view of another sub-pixel group in a display panel provided in an embodiment of the present application;

FIG. 21 is a schematic structural diagram showing a top view of another sub-pixel group in a display panel provided in an embodiment of the present application;

FIG. 22 is a schematic structural diagram showing a top view of another sub-pixel group in a display panel provided in an embodiment of the present application;

FIG. 23 is a schematic structural diagram showing a top view of another sub-pixel group in a display panel provided in an embodiment of the present application;

FIG. 24 is a schematic diagram showing a top view of a pixel unit in a display panel provided in an embodiment of the present application; and

FIG. 25 shows a schematic structural diagram of a display device provided in an embodiment of the present application.

### DETAILED DESCRIPTION

The features and exemplary embodiments of various aspects of the present application will be described in detail below. In order to make the purpose, technical solutions and advantages of the present application clearer, the present application will be further described in detail below in conjunction with the accompanying drawings and specific embodiments. It should be understood that the specific embodiments described herein are only configured to explain the present application and are not configured to limit the present application. For those skilled in the art, the present application can be implemented without the need for some of these specific details. The following description of the embodiments is only to provide a better understanding of the present application by illustrating the examples of the present application.

It should be noted that, in this article, relational terms such as first and second, etc. are only configured to distinguish one entity or operation from another entity or operation, and do not necessarily require or imply any such actual relationship or order between these entities or operations. Moreover, the terms “comprise”, “comprising” or any other variants thereof are intended to cover non-exclusive inclusion, so that a process, method, article or device including a series of elements comprises not only those elements, but also other elements not explicitly listed, or also comprises elements inherent to such process, method, article or device. In the absence of further restrictions, the elements defined by the statement “comprise . . . ” do not exclude the presence of other identical elements in the process, method, article or device including the elements.

It should be understood that when describing the structure of a component, when a layer or a region is referred to as being “on” or “over” another layer or another region, it may mean that it is directly on the other layer or another region, or that other layers or regions are comprised between it and the other layer or another region. Moreover, if the component is turned over, the layer or a region will be “below” or “beneath” another layer or another region.

It should be understood that the term “and/or” used in this article is only a description of the association relationship of associated objects, indicating that there can be three relationships. For example, A and/or B can represent: A exists alone, A and B exist at the same time, and B exists alone. In addition, the character “/” in this article generally indicates that the associated objects before and after are in an “or” relationship.

In the embodiments of the present application, the term “electrically connected” may refer to a direct electrical connection between two components, or may refer to an electrical connection between two components via one or more other components.

It is obvious to those skilled in the art that various modifications and changes can be made in this application without departing from the spirit or scope of this application. Therefore, this application is intended to cover modifications and changes of this application that fall within the scope of the corresponding claims (technical solutions claimed for protection) and their equivalents. It should be noted that the implementation methods provided in the embodiments of this application can be combined with each other without contradiction.

Embodiments of the present application provide a display panel and a display device, which will be described below in conjunction with the accompanying drawings.

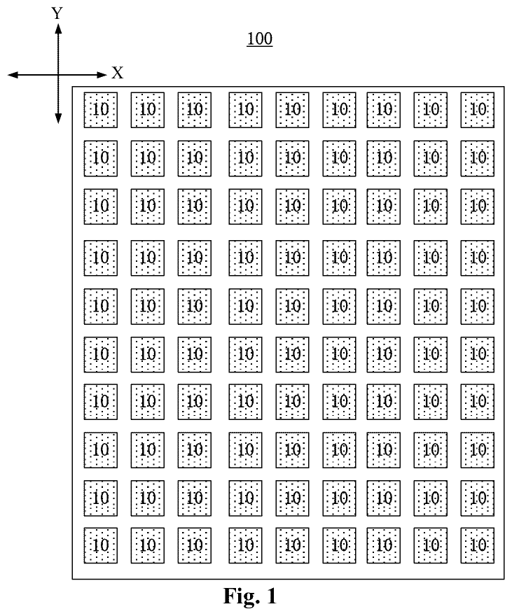

FIG. 1 is a structural schematic diagram of a display panel provided in an embodiment of the present application. FIGS. 2 to 5 are schematic structural diagrams of sub-pixel groups in a display panel provided in embodiments of the present application.

Referring to FIGS. 1 to 5, the display panel 100 provided in the embodiment of the present application comprises sub-pixel groups 10. The sub-pixel group 10 comprises n driving circuits 11 and m light-emitting elements. The output ends of the n driving circuits 11 are electrically connected to the m light-emitting elements.

The m light-emitting elements comprise n first light-emitting elements D1 and i second light-emitting elements D2, the output ends of the n driving circuits 11 are electrically connected to the n first light-emitting elements D1 in a one-to-one correspondence, and the output end of at least one driving circuit 11 is electrically connected to the second light-emitting element(s) D2 via an interpolation unit 12, the second light-emitting element D2 is electrically connected to a compensation unit 13, where n+i=m, m, n, i are all integers greater than 0, the interpolation unit 12 is configured to transmit the driving signal from the driving circuit 11 to the second light-emitting element D2, and the compensation unit 13 is configured to compensate the second light-emitting element D2 with the driving signal.

Exemplarily, as shown in FIG. 1, a plurality of sub-pixel groups 10 in the display panel are arranged in an array in a first direction X and a second direction Y that intersect.

The driving circuit 10 is configured to drive the light emitting element to emit light. Exemplarily, the driving circuit 10 provides a driving current to the light emitting element electrically connected thereto, thereby driving the light emitting element to emit light.

It can be understood that, in the same sub-pixel group 10, the number n of the driving circuits 11 is less than the number m of the light-emitting elements, where the number m of the light-emitting elements is the sum of the number of the first light-emitting elements and the number of the second light-emitting elements. In the same sub-pixel group 10, the n driving circuits 11 are shared by the m light-emitting elements, so that a smaller number of driving circuits can be configured to drive a larger number of light-emitting elements. In the case that the size of the display panel is constant, a larger number of light-emitting elements can be provided, thereby improving the display resolution.

For example, as shown in FIG. 2, in the same sub-pixel group 10, the number of the driving circuit 11 is one, and the numbers of the first light-emitting element D1 and the second light-emitting element D2 are both one. In this example, one driving circuit 11 is configured to drive two light-emitting elements.

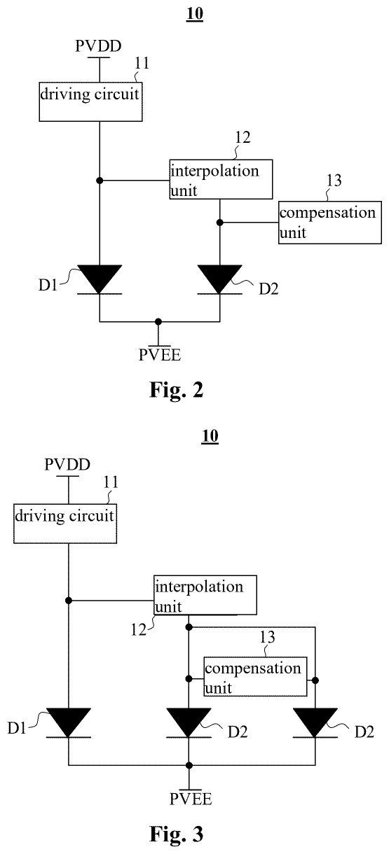

For another example, as shown in FIG. 3, in the same sub-pixel group 10, the number of the driving circuit 11 is one, the number of the first light-emitting element D1 is one, and the number of the second light-emitting elements D2 is two. In this example, one driving circuit 11 is configured to drive three light-emitting elements.

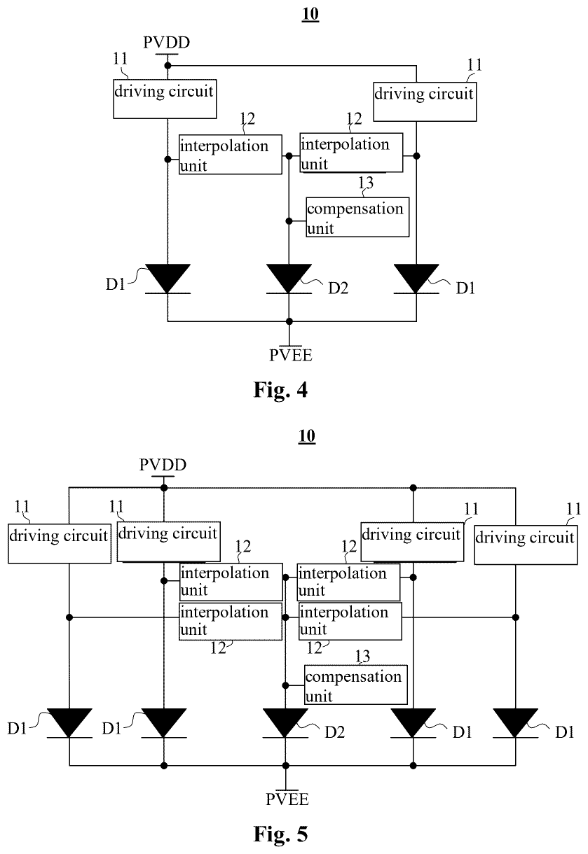

For another example, as shown in FIG. 4, in the same sub-pixel group 10, the number of driving circuits 11 is 2, the number of first light-emitting elements D1 is 2, and the number of second light-emitting elements D2 is 1. In this example, two driving circuits 11 are configured to drive three light-emitting elements.

For another example, as shown in FIG. 5, in the same sub-pixel group 10, the number of driving circuits 11 is 4, the number of first light-emitting elements D1 is 4, and the number of second light-emitting elements D2 is 1. In this example, the four driving circuits 11 are configured to drive five light-emitting elements.

Of course, FIGS. 2 to 5 are merely examples and are not intended to limit the present application.

As shown in FIGS. 2 to 5, in the same sub-pixel group 10, the number of driving circuits 11 is equal to the number of first light-emitting elements D1. No interpolation unit is connected between the output end of the driving circuit 11 and the first light-emitting element D1, and an interpolation unit 12 is connected between the output end of the driving circuit 11 and the second light-emitting element D2. It can be understood that, the driving circuit 11 directly drives the first light-emitting element D1, and the driving circuit 11 drives the second light-emitting element D2 after passing through the interpolation unit 13. “Interpolation” can be understood as shunting the driving current generated by the driving circuit 11 and transmitting the shunted current to the second light-emitting element D2.

Exemplarily, in the case that one second light-emitting element D2 is electrically connected to a plurality of driving circuits 11, the interpolation unit 12 is connected between the second light-emitting element D2 and each of the plurality of driving circuits 11.

For example, as shown in FIG. 4, an interpolation unit 12 is connected between a second light emitting element D2 and each of two driving circuits 11. In this example, two interpolation units 12 shunt the driving currents generated by the two driving circuits 11, respectively. The shunt of one interpolation unit 12 is I₁, and the shunt of the other interpolation unit 12 is I₂. The total current obtained by the second light emitting element D2 is I₁+I₂.

Alternatively, as shown in FIG. 5, an interpolation unit 12 is connected between the second light-emitting element D2 and each of the four driving circuits 11. In this example, the four interpolation units 12 shunt the driving currents generated by the four driving circuits 11, respectively, and the shunts of the four interpolation units 12 are I₁₁, I₁₂, I₁₃, and I₁₄, respectively, and the total current obtained by the second light-emitting element D2 is I₁₁+I₁₂+I₁₃+I₁₄.

In the case that the driving circuit is used by both the first light-emitting element and the second light-emitting element, when the second light-emitting element needs to emit light at high brightness, it is prone to cause insufficient driving signal allocated to the second light-emitting element. In serious cases, the light-emitting element cannot even be driven, resulting in problems such as poor display uniformity.

In view of this, in the embodiments of the present application, a compensation unit 13 is further provided to compensate the driving signal to the second light emitting element D2.

Exemplarily, the compensation unit 13 is configured to provide a compensation current to the second light-emitting element D2. For example, in the case that the current shunted by the interpolation unit 12 from the driving circuit 11 is insufficient to meet the brightness requirement of the second light-emitting element D2, the compensation unit 13 is started, and the compensation unit 13 provides a compensation current to the second light-emitting element D2. The current shunted through interpolation of the interpolation unit 12 and the current compensated by the compensation unit 13 jointly drive the second light-emitting element D2 to meet the brightness requirement of the second light-emitting element D2.

According to the display panel provided in the embodiments of the present application, n driving circuits are configured to drive m light-emitting elements, where n is less than m, thereby reducing the number of driving circuits and enabling more light-emitting elements to be arranged in a limited space, improving the display resolution of the display panel; in addition, the compensation unit is configured to compensate the driving signal to the second light-emitting element, and the driving signal obtained by the interpolation unit from the driving circuit and the compensation signal provided in the compensation unit jointly drive the second light-emitting element to meet the brightness requirement of the second light-emitting element, thereby improving the display resolution while ensuring the normal light-emitting ability of the light-emitting element.

In some embodiments, in the same sub-pixel group, the number i of the second light-emitting elements is greater than or equal to the number n of the driving circuits.

For an example, as shown in FIG. 2, in the same sub-pixel group 10, the number of the second light-emitting elements D2 is equal to the number of the driving circuits 11. In this example, one driving circuit 11 is shunted by one second light-emitting element D2.

For another example, as shown in FIG. 3, in the same sub-pixel group 10, the number of the second light-emitting elements D2 is greater than the number of the driving circuits 11. In this example, one driving circuit 11 is shunted by two second light-emitting elements D2.

Of course, in other examples, one driving circuit 11 is shunted by three, four or even more second light-emitting elements D2.

In this embodiment, it is designed that one driving circuit is shunted by one or more second light-emitting elements, and more second light-emitting elements can be arranged in a limited space to improve the display resolution.

In some embodiments, in the case that a driving circuit is shunted by multiple second light-emitting elements, the output end of at least one driving circuit is electrically connected to the multiple second light-emitting elements via the same interpolation unit; or, at least two second light-emitting elements are each electrically connected to the output end of the same driving circuit via a different interpolation unit.

For example, referring to FIG. 3, one driving circuit 11 is shunted by two second light emitting elements D2, and the driving circuit 11 is electrically connected to the two second light emitting elements D2 via the same interpolation unit 12. The driving current shunted by the interpolation unit 12 from the driving circuit 11 can flow to the two second light emitting elements D2.

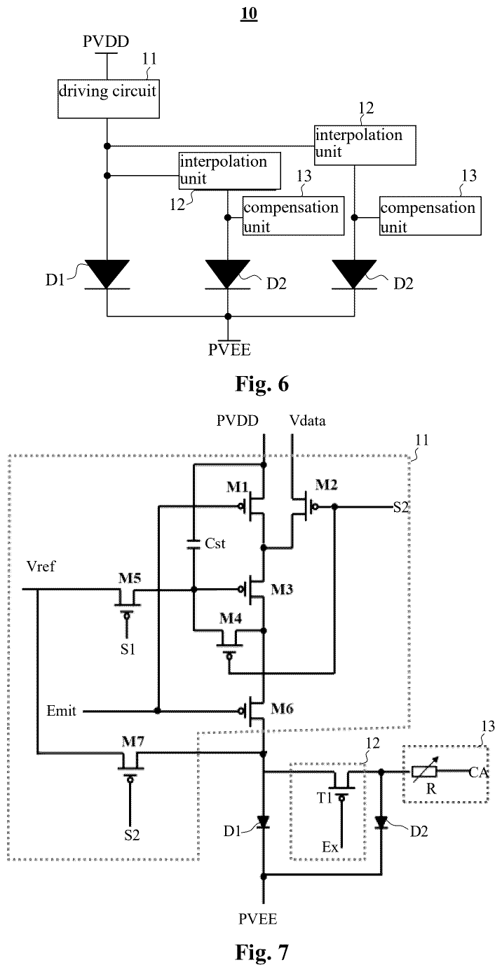

Alternatively, as shown in FIG. 6, one driving circuit 11 is shunted by two second light-emitting elements D2, the driving circuit 11 is electrically connected to one of the second light-emitting elements D2 via an interpolation unit 12, and the driving circuit 11 is electrically connected to the other second light-emitting element D2 via another interpolation unit 12. The two interpolation units 12 shun the driving circuit 11 respectively, and the driving currents shunted by the two interpolation units 12 are the same or different.

In this embodiment, multiple second light-emitting elements are electrically connected to the same driving circuit via the same interpolation unit. Multiple second light-emitting elements share the interpolation unit, which can reduce the number of interpolation units and help further improve the display resolution. At least two second light-emitting elements are each electrically connected to the output end of the same driving circuit via different interpolation units, and the shunt of each interpolation unit can be adjusted separately to meet the brightness requirements of different second light-emitting elements.

In some other embodiments, in the same sub-pixel group, the number i of the second light-emitting elements is less than the number n of the driving circuits.

For an example, as shown in FIG. 4, in the same sub-pixel group 10, the number of the second light-emitting elements D2 is less than the number of the driving circuits 11. In this example, two driving circuits 11 are shunted by one second light-emitting element D2.

For another example, as shown in FIG. 5, in the same sub-pixel group 10, the number of the second light-emitting elements D2 is less than the number of the driving circuits 11. In this example, four driving circuits 11 are shunted by one second light-emitting element D2.

In this embodiment, it is designed that multiple driving circuits are shunted by one second light-emitting element, and the driving current of the second light-emitting element is the sum of the currents of the multiple driving circuits shunted by the interpolation unit, which makes it easier to meet the brightness requirements of the second light-emitting element.

In some embodiments, in the case that multiple driving circuits are shunted by one second light-emitting element, at least one second light-emitting element is electrically connected to output ends of different driving circuits via different interpolation units.

For example, as shown in FIG. 4, two driving circuits 11 are shunted by a second light-emitting element D2, wherein one driving circuit 11 is electrically connected to the second light-emitting element D2 via an interpolation unit 12, and the other driving circuit 11 is electrically connected to the second light-emitting element D2 via another interpolation unit 12. The driving currents shunted from the two driving circuits 11 by the two interpolation units 12 respectively are converged and flowed to the second light-emitting element D2.

For another example, as shown in FIG. 5, four driving circuits 11 are shunted by one second light-emitting element D2, and the four driving circuits 11 are electrically connected to the second light-emitting element D2 via four interpolation units 12. The four interpolation units 12 converge the driving currents obtained from the four driving circuits 11 and flow them to the second light-emitting element D2.

In this embodiment, a second light-emitting element is electrically connected to the output ends of different driving circuits via different interpolation units, so that the current shunted by each interpolation unit from each driving circuit can flow to the second light-emitting element, avoiding short circuit between the output ends of multiple driving circuits, thereby ensuring normal driving of the first light-emitting element and the second light-emitting element.

In some embodiments, whether one driving circuit is shunted by multiple second light-emitting elements, or multiple driving circuits are shunted by one second light-emitting element, it can be designed as: at least the same compensation unit is electrically connected to multiple second light-emitting elements; or, at least two second light-emitting elements are each electrically connected to a different compensation unit.

For example, as shown in FIG. 3, the same compensation unit 13 is electrically connected to two second light emitting elements D2, and the compensation unit 13 can compensate for the two second light emitting elements D2 electrically connected thereto.

Alternatively, as shown in FIG. 6, the two second light emitting elements D2 are respectively electrically connected to different compensation units 13, and each compensation unit 13 compensates the second light emitting element D2 electrically connected thereto.

It can be understood that, in the case that multiple second light-emitting elements share one compensation unit, the total number of compensation units in the display panel can be reduced, which is conducive to improving the display resolution. In the case that different second light-emitting elements are electrically connected to different compensation units, fine compensation of different second light-emitting elements can be achieved, thereby improving the display effect of each second light-emitting element.

It should be noted that FIGS. 2 to 6 only illustrate some examples of n driving circuits driving m light-emitting elements, where n is less than m, and these examples are not intended to limit the present application. For example, the number of light-emitting elements of a sub-pixel, the number of driving circuits, the connection method of the interpolation unit, the connection method of the compensation unit, etc. may be different from the examples shown in FIGS. 2 to 6.

The structures of the interpolation unit and the compensation unit are introduced as examples below.

In some embodiments, as shown in FIG. 7, the interpolation unit 12 comprises a first transistor M1, a first electrode of the first transistor M1 is electrically connected to the output end of the driving circuit 11, a second electrode of the first transistor M1 is electrically connected to the second light emitting element D2, and a gate of the first transistor M1 is connected to the first control signal Ex.

Taking an example that the first transistor M1 is a P-type transistor, in the case that the first control signal Ex is at a low level, the first transistor M1 is turned on, connecting the output end of the driving circuit 11 to the second light-emitting element D2, and at least part of the driving current at the output end of the driving circuit 11 can be transmitted to the second light-emitting element D2 via the first transistor M1, thereby driving the second light-emitting element D2 to emit light. In the case that the first control signal Ex is at a high level, the first transistor M1 is turned off, disconnecting the output end of the driving circuit 11 from the second light-emitting element D2, and the second light-emitting element D2 does not emit light.

In some embodiments, the first control signal Ex is the same as the light emitting control signal Emit connected to the driving circuit 11.

Exemplarily, taking FIG. 7 as an example, the structure of the driving circuit 11 is a “7T1C” structure, and the light emitting control signal Emit is configured to control the transistor M11 and the transistor M16. Of course, the structure of the driving circuit 11 is not limited to the “7T1C” structure, for example, it can also be “8T1C”, “8T2C”, “13T2C”, etc., “7T1C” means that the driving circuit comprises 7 transistors and 1 capacitor, and the same for other “8T1C”, “8T2C”, “13T2C”, etc.

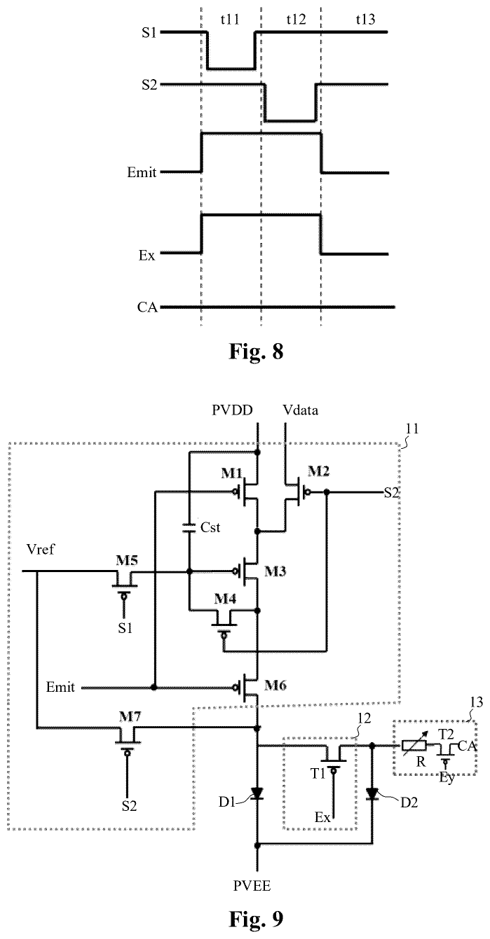

The following describes the working process of the sub-pixel group in combination with FIG. 7 and FIG. 8.

In phase t11, the scanning signal S1 controls the transistor M5 to turn on, and the reset signal Vref is written into the gate of the driving transistor M3 and the lower plate of the storage capacitor Cst to initialize the gate of the driving transistor M3 and the storage capacitor Cst.

In phase t12, the scanning signal S2 controls transistors M2, M4 and M7 to turn on, the data signal Vdata is written into the gate of the driving transistor M3, and the transistor M4 performs threshold voltage compensation on the driving transistor M3. In addition, the reset signal Vref is written into the anode of the first light emitting element D1 to reset the anode of the first light emitting element D1.

In phase t13, the light-emitting control signal Emit controls the transistors M1 and M6 to turn on, the first control signal Ex is the same as the light-emitting control signal Emit, the first control signal Ex controls the first transistor M1 to turn on, the driving current generated by the driving circuit 11 drives the first light-emitting element D1 to emit light normally, and the driving current generated by the driving circuit 11 is transmitted to the second light-emitting element D2 via the first transistor M1, and the second light-emitting element D2 emits light. If the driving current transmitted by the first transistor M1 is not enough to meet the brightness requirement of the second light-emitting element D2, the compensation unit 13 can be activated to perform current compensation on the second light-emitting element D2 at this time, so that the total driving current meets the brightness requirement of the second light-emitting element D2.

In the case that the first control signal Ex and the light emitting control signal Emit are the same, the driving circuit 11 can drive the first light emitting element D1 and the second light emitting element D2 to emit light simultaneously.

In other embodiments, the first control signal Ex is independent of the light emitting control signal Emit, so that the opening degree of the first transistor M1 can be controlled by adjusting the first control signal Ex, thereby adjusting the current transmitted by the first transistor to the second light emitting element.

In the case that the driving current output by the driving circuit is constant, the greater the degree of opening of the first transistor, the greater the current transmitted by the first transistor to the second light-emitting element, that is, the more diversion the second light-emitting element obtains; conversely, the smaller the degree of opening of the first transistor, the smaller the current transmitted by the first transistor to the second light-emitting element, that is, the less shunt current the second light-emitting element obtains.

In some embodiments, the compensation unit 13 comprises a resistor R, one end of the resistor R is electrically connected to the compensation voltage end CA, and the other end of the resistor R is electrically connected to the second light emitting element D2.

In the case that the second light-emitting element D2 needs to be compensated, the voltage of the compensation voltage end CA is greater than the voltage of the common voltage end PVEE, and a current is generated on the path along the compensation voltage end CA, the resistor R, and the second light-emitting element D2. This current is the current that the compensation unit 13 uses to compensate the second light-emitting element D2.

In some embodiments, at least one of the resistance value of the resistor R of the compensation unit 13 or the voltage value of the compensation voltage end CA is adjustable.

For example, the resistance value of the resistor R is adjustable, and the voltage of the compensation voltage end CA is a constant voltage. The current magnitude of the second light-emitting element D2 compensated by the compensation unit 13 is realized by adjusting the resistance value of the resistor R. In the case that the voltage of the compensation voltage end CA is constant, the larger the resistance value of the resistor R, the smaller the compensation current value; conversely, the smaller the resistance value of the resistor R, the larger the compensation current value.

For another example, the resistance value of the resistor R is constant, and the voltage value of the compensation voltage end CA is adjustable. By adjusting the voltage value of the compensation voltage end CA, the current magnitude of the second light-emitting element D2 compensated by the compensation unit 13 is realized. In the case that the resistance value of the resistor R is constant, the larger the voltage value of the compensation voltage end CA, the larger the compensation current value; conversely, the smaller the voltage value of the compensation voltage end CA, the smaller the compensation current value.

For another example, the resistance value of the resistor R is adjustable, and the voltage value of the compensation voltage end CA is adjustable. By adjusting the resistance value of the resistor R and the voltage value of the compensation voltage end CA, the current magnitude compensated by the compensation unit 13 for the second light emitting element D2 is realized.

In this embodiment, at least one of the resistance value of the resistor R or the voltage value of the compensation voltage end CA is adjustable, so that the magnitude of the compensation current can be adjusted to achieve fine compensation.

In some embodiments, in the case that the second light-emitting element does not need to be compensated, and the resistance value of the resistor R is adjustable, the resistance value of the resistor is infinite, and/or in the case that the second light-emitting element does not need to be compensated, and the voltage value of the compensation voltage end is adjustable, the compensation voltage end does not output a voltage. The fact that the compensation voltage end does not output a voltage can be understood as the compensation voltage end being floating.

The situation where the second light emitting element does not need to be compensated comprises: the current obtained by the second light emitting element from the interpolation unit meets its brightness requirement, and/or the second light emitting element does not need to emit light.

In this embodiment, in the case that the second light-emitting element does not need to be compensated, the resistance value of the resistor is infinite, and/or the compensation voltage end does not output a voltage, and the compensation function of the compensation unit is turned off to avoid unnecessary compensation of the second light-emitting element by the compensation unit.

Exemplarily, in the case that the turn-off capability of the second light-emitting element is insufficient, the compensation voltage end CA is at a negative level, so that the second light-emitting element achieves a better black state.

In some embodiments, as shown in FIG. 9, the compensation unit 13 further comprises a second transistor M2, and the second transistor M2 is connected in series with a resistor R. The second transistor M2 is electrically connected between the resistor R and the compensation voltage end CA, or the second transistor M2 is electrically connected between the resistor R and the second light-emitting element D2. The gate of the second transistor M2 is connected to the second control signal Ey. For example, the second transistor M2 is a P-type transistor, and in the case that the second control signal Ey is at a low level, the second transistor M2 is turned on, in which case the compensation unit can compensate the second light-emitting element; in the case that the second control signal Ey is at a high level, the second transistor M2 is turned off, in which case the compensation unit cannot compensate the second light-emitting element.

In this embodiment, a second transistor is provided, and whether to start the compensation function of the compensation unit can be realized by controlling the state of the second transistor.

It should be noted that, although the structures of the interpolation unit and the compensation unit are introduced by taking FIG. 7 and FIG. 9 as examples, the specific structures of the interpolation unit and the compensation unit introduced in the above examples are applicable to any one of the architectures of FIG. 2 to FIG. 6.

Exemplarily, the light emitting element comprises a micro light emitting diode (micro LED) or a mini light emitting diode (Mini LED) or an organic light emitting diode (OLED).

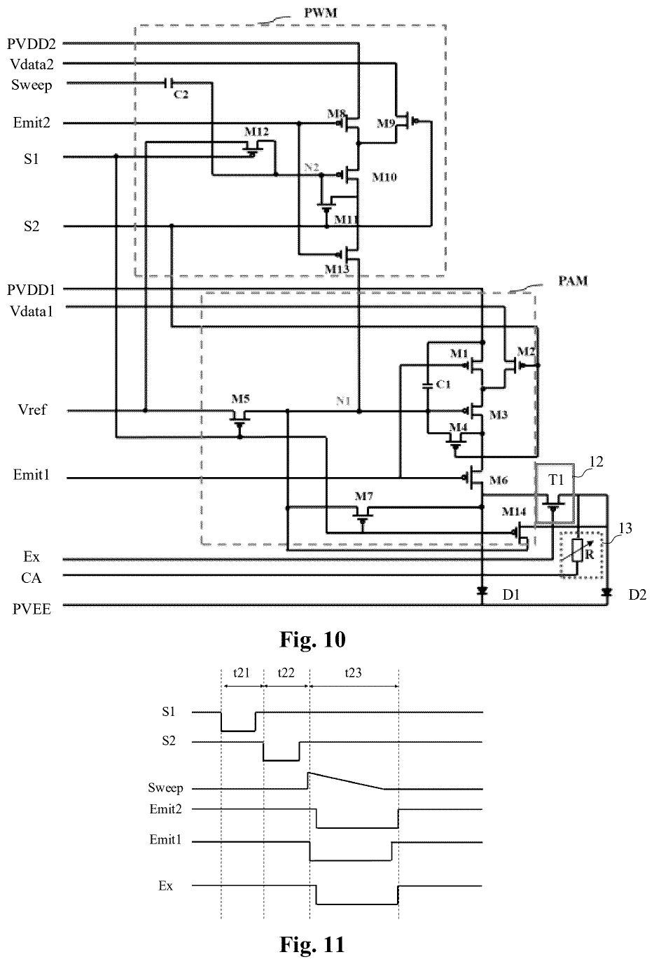

For example, as shown in FIG. 10, the driving circuit comprises a pulse amplitude modulation (PAM) sub-circuit and a pulse width modulation (PWM) sub-circuit to control the intensity of the driving current and the duration of the driving current to control the light-emitting state of the light-emitting element.

The PAM sub-circuit is connected to the PWM sub-circuit. The driving circuit generates a driving current under the control of the PAM sub-circuit and the PWM sub-circuit. The PAM sub-circuit is configured to control the amplitude of the driving current, and the PWM sub-circuit is configured to adjust the pulse width of the voltage applied to the first electrode of the light-emitting element.

The PWM sub-circuit adjusts the pulse width of the voltage applied to the first electrode of the light-emitting element, that is, the PWM sub-circuit adjusts the actual emission period of the driving current applied to the light-emitting element, while keeping the driving current applied to the light-emitting element at a constant level to adjust the grayscale or brightness displayed by the light-emitting element, rather than adjusting the grayscale or brightness displayed by the light-emitting element only by adjusting the magnitude of the driving current applied to the light-emitting element. Therefore, the PAM sub-circuit can provide the driving current to the light-emitting element so that the light-emitting element is driven with the best luminous efficiency, and adjust the grayscale or brightness displayed by the light-emitting element by adjusting the light-emitting duty cycle of the light-emitting element (that is, the emission period of the light-emitting element) via the PWM sub-circuit.

As shown in FIG. 10, the interpolation unit comprises a first transistor T1, and the compensation unit comprises a resistor R, which is electrically connected between the compensation voltage end CA and the second light emitting element D2.

The following describes the working process of the sub-pixel in combination with FIG. 10 and FIG. 11.

In phase t21, the scanning signal S1 controls the transistors M7 and M14 to turn on, and the reset signal Vref resets the anodes of the first light-emitting element D1 and the second light-emitting element D2; at the same time, the scanning signal S1 controls the transistors M5 and M12 to turn on, and the reset signal Vref is written to the nodes N1 and N2 to initialize the gates of the driving transistors M10 and M3.

In phase t22, the scanning signal S2 controls the transistors M2 and M4 to turn on, the data signal DATA1 is written to the node N1, and the transistor M4 compensates the threshold voltage of the driving transistor, the potential of the node N1 is equal to DATA1+Vth(M3), and the write capacitor C1 is stored; at the same time, the scanning signal S2 controls the transistors M9 and M11 to turn on, the data signal DATA2 is written to the node N2, the transistor M11 compensates for the threshold voltage of the driving transistor M10, the potential of the node N2 is equal to DATA2+Vth(M10), and the write capacitor C2 is stored.

In phase t23, the first light-emitting control signal EM1, the second light-emitting control signal EM2, and the first control signal EX are at a low level, the transistors M8/M13/M1/M6/T1 are turned on, the Vgs (M10) of the driving transistor M10 is Vsweep-VDD2, and sweep decreases linearly from a high level to a low level under the coupling effect of the capacitor C2, and the driving transistor M10 is gradually turned on until the node N1=PVDD2. At the same time, the Vgs (M3) of the driving transistor M3 is N1-PVDD1=PVDD2−PVDD1, the driving transistor M3 is turned on, and the first light-emitting element D1 emits light. As PVDD2 increases, Vgs (M3)<Vth, the driving transistor M3 is turned off, and the first light-emitting element D1 does not emit light, that is, it enters a black state. In this process, in the case that the driving transistor M3 is turned on, the driving current is also directed to the second light-emitting element D2 via the first transistor T1, and the second light-emitting element D2 emits light. In the case that the current intensity obtained by the second light-emitting element D2 from the first transistor T1 is insufficient, the current can be increased by the compensation unit. In the case that the driving transistor M3 is turned off, the second light-emitting element D2 is turned off, and in the case that the turning-off ability is insufficient, the compensation signal end CA can be adjusted to a negative level, so that the second light-emitting element D2 can achieve a better black state.

It can be understood that, that the examples shown in FIG. 7, FIG. 9 and FIG. 10 correspond to the architecture shown in FIG. 2, that is, one driving circuit drives one first light-emitting element and one second light-emitting element.

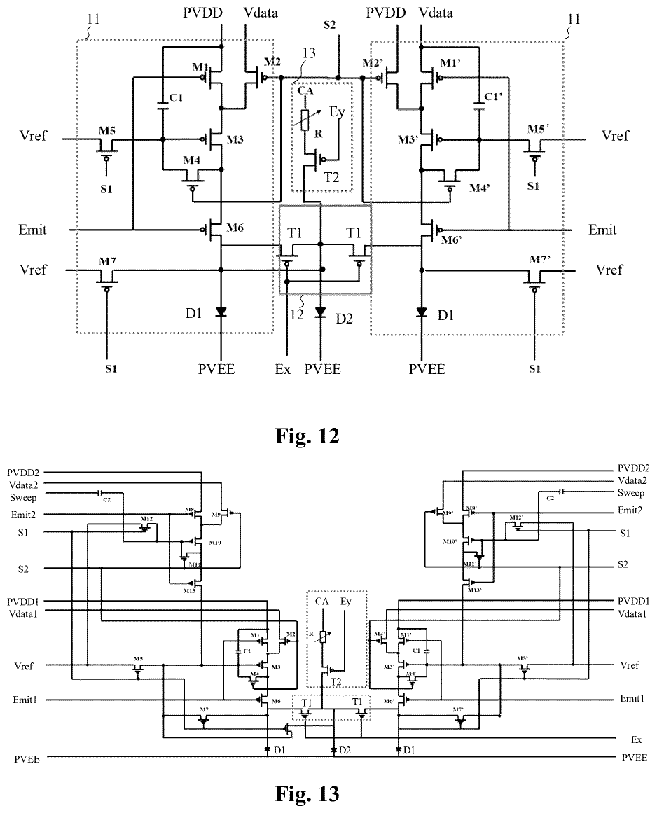

In other embodiments, the specific circuit structure of the sub-pixel group may also be a structure as shown in FIG. 12 or 13. It can be understood that the examples shown in FIGS. 12 and 13 correspond to the architecture shown in FIG. 2, that is, one driving circuit drives two first light-emitting elements and one second light-emitting element. In addition, in FIGS. 12 and 13, the second light-emitting element D2 is electrically connected to different driving circuits 11 via different first transistors T1, the compensation unit 13 comprises a second transistor T2 connected in series with the resistor R, and the second control signal Ey and the first control signal Ex may be the same.

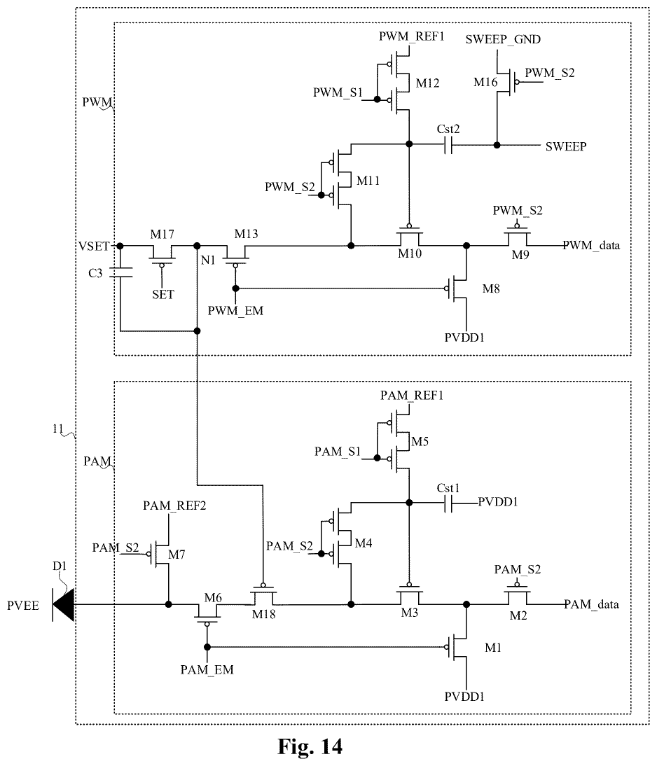

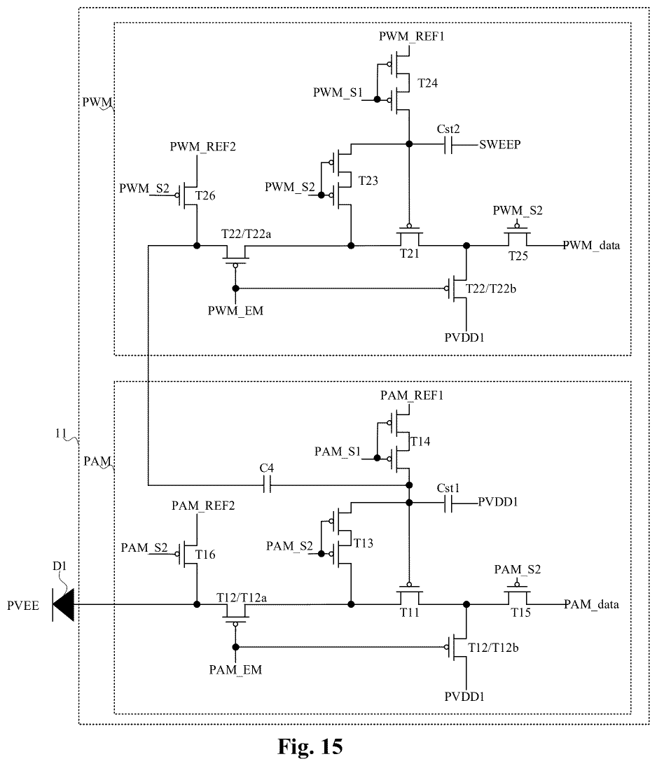

It should be noted that, in the case that the driving circuit 11 comprises a PAM sub-circuit and a PWM sub-circuit, the circuit structure of the driving circuit 11 may also be illustrated as shown in FIG. 14 or 15. In addition, the scanning signals S1\S2, the light emitting control signal, the reset signal, etc. connected to the PAM sub-circuit and the PWM sub-circuit may also be differentiated.

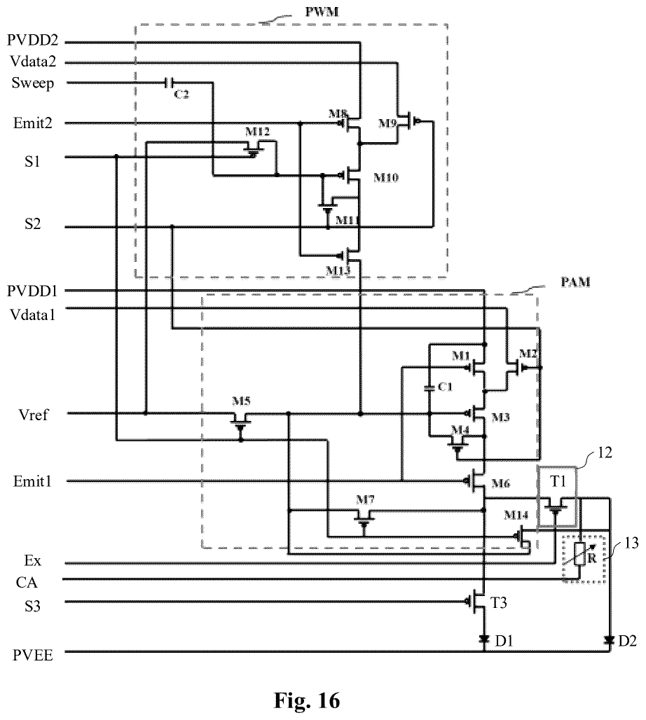

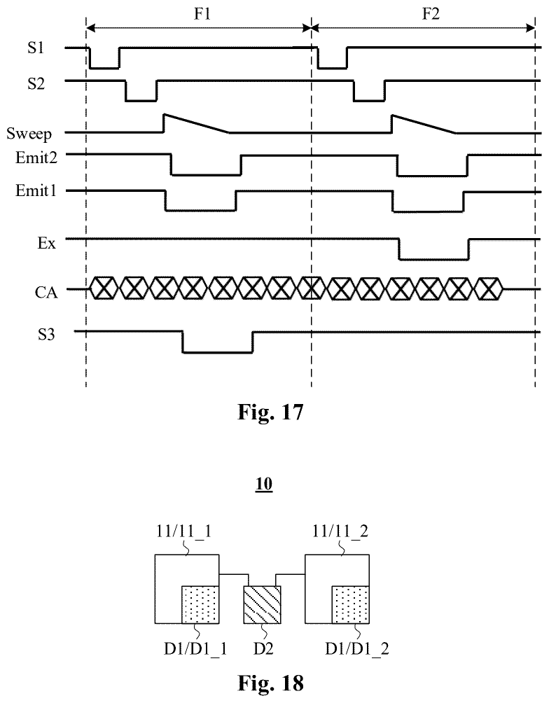

In some embodiments, referring to FIGS. 16 and 17, the output end of the driving circuit is electrically connected to the first light-emitting element D1 via the third transistor T3. A picture refresh frame of the display panel comprises at least a first sub-frame F1 and a second sub-frame F2. In the first sub-frame F1, the third transistor T3 is turned on and the interpolation unit 12 is turned off; in the second sub-frame F2, the third transistor T3 is turned off and the interpolation unit 12 is turned on.

Exemplarily, the third transistor T3 is controlled by the scanning signal S3. In the light-emitting phase of the first sub-frame F1, the scanning signal S3 is at a low level, and the third transistor T3 is turned on. In the non-light-emitting phase of the first sub-frame F1, the scanning signal S3 is at a high level, and the third transistor T3 is turned off. In the second sub-frame F2, the scanning signal S3 remains at a high level.

In the case that the third transistor T3 is turned on, the driving current output by the driving circuit can be transmitted to the first light emitting element D1 to drive the first light emitting element D1 to emit light.

The interpolation unit 12 comprises a first transistor T1, which is controlled by a first control signal Ex. In the light-emitting phase of the second sub-frame F2, the first control signal Ex is at a low level, and the first transistor T1 is turned on. In the non-light-emitting phase of the second sub-frame F2, the first control signal Ex is at a high level, and the first transistor T1 is turned off. In the first sub-frame F1, the first control signal Ex remains at a high level.

In the case that the first transistor T1 is turned on, the driving current output by the driving circuit can be transmitted to the second light emitting element D2 to drive the second light emitting element D2 to emit light.

In this embodiment, the driving circuit drives the first light emitting element and the second light emitting element in a time-sharing manner, so that the brightness requirements of the first light emitting element and the second light emitting element can be easily met.

It should be noted that the first light-emitting element is electrically connected to the output end of the driving circuit via the third transistor and is not limited to the circuit structure shown in FIG. 16. In the circuit structure shown in any of FIGS. 2 to 7, 9 to 10, and 12 to 15, a third transistor can be added between the output end of the driving circuit and the first light-emitting element.

In some embodiments, the display panel comprises a plurality of sub-pixel groups, and the connection relationship between the driving circuit and the light-emitting element in each sub-pixel group is the same.

The connection relationship between the driving circuit and the light-emitting element in the sub-pixel group comprises: the connection relationship between the driving circuit and the first light-emitting element and the second light-emitting element. The connection relationship between the driving circuit and the light-emitting element in the two sub-pixel groups is the same, comprises: the number of driving circuits in the two sub-pixel groups is equal, the number of first light-emitting elements in the two sub-pixel groups is equal, the number of second light-emitting elements in the two sub-pixel groups is equal, and the driving circuits and the first light-emitting elements in the two sub-pixel groups are connected one-to-one, and the number of driving circuits connected to the second light-emitting elements in the two sub-pixel groups is equal.

For example, the connection relationship between the driving circuit and the light-emitting element in each sub-pixel group is shown in FIG. 2. Alternatively, the connection relationship between the driving circuit and the light-emitting element in each sub-pixel group is shown in FIG. 3. Alternatively, the connection relationship between the driving circuit and the light-emitting element in each sub-pixel group is shown in FIG. 4. Alternatively, the connection relationship between the driving circuit and the light-emitting element in each sub-pixel group is shown in FIG. 5. Alternatively, the connection relationship between the driving circuit and the light-emitting element in each sub-pixel group is shown in FIG. 6.

In this embodiment, the connection relationship between the driving circuit and the light-emitting element of each sub-pixel group is the same, which is easier to implement in layout design and avoids increasing the difficulty of the process.

In other embodiments, the sub-pixel group of the display panel comprises at least a first sub-pixel group and a second sub-pixel group, and the connection relationship between the driving circuit and the light-emitting element in the first sub-pixel group is different from the connection relationship between the driving circuit and the light-emitting element in the second sub-pixel group.

Exemplarily, the connection relationship between the driving circuit and the light-emitting element in the first sub-pixel group is shown in any one of FIGS. 2 to 6, and the connection relationship between the driving circuit and the light-emitting element in the first sub-pixel group is shown in any other one of FIGS. 2 to 6.

For example, the connection relationship between the driving circuit and the light-emitting element in the first sub-pixel group is shown in FIG. 2, and the connection relationship between the driving circuit and the light-emitting element in the second sub-pixel group is shown in FIG. 3. Alternatively, the connection relationship between the driving circuit and the light-emitting element in the first sub-pixel group is shown in FIG. 4, and the connection relationship between the driving circuit and the light-emitting element in the second sub-pixel group is shown in FIG. 5. Alternatively, the connection relationship between the driving circuit and the light-emitting element in the first sub-pixel group is shown in FIG. 2, and the connection relationship between the driving circuit and the light-emitting element in the second sub-pixel group is shown in FIG. 6.

In this embodiment, the connection relationship between the driving circuit and the light-emitting element in the first sub-pixel group is different from the connection relationship between the driving circuit and the light-emitting element in the second sub-pixel group, which facilitates flexible design according to different brightness requirements.

In some embodiments, the connection relationship between the driving circuit and the light-emitting element in the first sub-pixel group and the connection relationship between the driving circuit and the light-emitting element in the second sub-pixel are different, comprises: the number of first light-emitting elements in the first sub-pixel group and the number of first light-emitting elements in the second sub-pixel group are different, and/or, the number of second light-emitting elements in the first sub-pixel group and the number of second light-emitting elements in the second sub-pixel are different, and/or, the number of interpolation units in the first sub-pixel group and the number of interpolation units in the second sub-pixel are different, and/or, the number of compensation units in the first sub-pixel group and the number of compensation units in the second sub-pixel are different.

The number of driving circuits and the number of first light-emitting elements in the same sub-pixel group are the same. Therefore, that the connection relationship between the driving circuit and the light-emitting element in the first sub-pixel group is different from the connection relationship between the driving circuit and the light-emitting element in the second sub-pixel group comprises: the number of driving circuits in the first sub-pixel group and the number of driving circuits in the second sub-pixel group are different.

For example, the first sub-pixel group is the sub-pixel group shown in FIG. 2, the second sub-pixel group is the sub-pixel group shown in FIG. 3, the number of first light-emitting elements in FIG. 2 is equal to the number of first light-emitting elements in FIG. 3, but the number of second light-emitting elements in FIG. 2 is equal to the number of second light-emitting elements in FIG. 3.

For another example, the first sub-pixel group is the sub-pixel group shown in FIG. 4, the second sub-pixel group is the sub-pixel group shown in FIG. 5, the number of first light-emitting elements in FIG. 4 is different from the number of first light-emitting elements in FIG. 5, and the number of second light-emitting elements in FIG. 4 is equal to the number of second light-emitting elements in FIG. 5.

For another example, the first sub-pixel group is the sub-pixel group shown in FIG. 3, the second sub-pixel group is the sub-pixel group shown in FIG. 6, the number of first light-emitting elements in FIG. 3 is equal to the number of first light-emitting elements in FIG. 6, the number of second light-emitting elements in FIG. 3 is equal to the number of second light-emitting elements in FIG. 6, the number of interpolation units in FIG. 3 is different from the number of interpolation units in FIG. 6, and the number of compensation units in FIG. 3 is different from the number of compensation units in FIG. 6.

In some embodiments, taking FIG. 18 as an example, the first light emitting element D1 and the second light emitting element D2 are adjacent to each other in the same sub-pixel group 10. The first light emitting element D1 and the second light emitting element D2 need to be electrically connected to the same driving circuit. In the case that the first light emitting element D1 and the second light emitting element D2 are adjacent to each other, the length of the connection line between the first light emitting element D1 and the second light emitting element D2 and the driving circuit can be prevented from being too long.

In the same sub-pixel group 10, the driving circuit 11 and the first light-emitting element D1 correspond one to one. Exemplarily, orthographic projections of the driving circuit 11 and the first light-emitting element D1 that are electrically connected to each other on the plane where the display panel is located at least partially overlap. For example, in FIG. 18, the 1st driving circuit 11_1 is electrically connected to the 1st first light-emitting element D1_1, and the orthographic projections of the 1st driving circuit 11_1 and the 1st first light-emitting element D1_1 on the plane where the display panel is located at least partially overlap; for another example, the 2nd driving circuit 11_2 is electrically connected to the 2nd first light-emitting element D1_2, and the orthographic projections of the 2nd driving circuit 11_2 and the 2nd first light-emitting element D1_2 on the plane where the display panel is located at least partially overlap. The first light-emitting element and the driving circuit that are electrically connected to each other are arranged nearby, which can shorten the length of the connecting line between the two. The two are arranged nearby, which can shorten the length of the connecting line between the two.

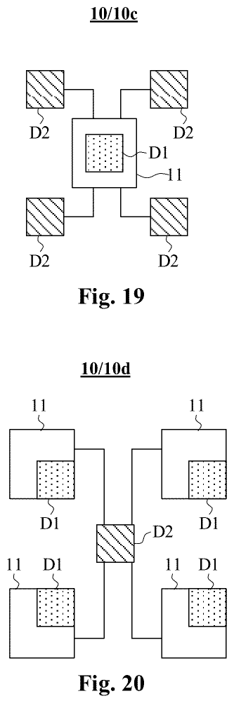

In some embodiments, as shown in FIG. 19, the sub-pixel group 10 comprises a third sub-pixel group 10c, in which the number i of the second light-emitting elements D2 is greater than the number n of the driving circuits 11. The number of the driving circuits 11 is equal to the number of the first light-emitting elements D1, and therefore, in the third sub-pixel group 10c, the number of the second light-emitting elements D2 is greater than the number of the first light-emitting elements D1. In the third sub-pixel group 10c, i second light-emitting elements D2 are arranged around n first light-emitting elements D1.

For example in FIG. 19, the third sub-pixel group 10c comprises one driving circuit 11, one first light-emitting element D1 and four second light-emitting elements D2, and the four second light-emitting elements D2 are arranged around one first light-emitting element D1. Exemplarily, the orthographic projections of the driving circuit 11 and the first light-emitting element D1 electrically connected to each other in the third sub-pixel group 10c on the plane where the display panel is located at least partially overlap, so that the distance between the four second light-emitting elements D2 and the driving circuit 11 will not be too far, which can avoid the connection line between the second light-emitting element D2 and the driving circuit 11 being too long.

Additionally or alternatively, as shown in FIG. 20, the sub-pixel group 10 comprises a fourth sub-pixel group 10d, and for the fourth sub-pixel group 10d, the number i of the second light-emitting elements D2 is less than the number n of the driving circuits 11. The number of the driving circuits 11 is equal to the number of the first light-emitting elements D1, therefore, the number of the second light-emitting elements D2 in the fourth sub-pixel group 10d is less than the number of the first light-emitting elements D1. The n first light-emitting elements D1 in the fourth sub-pixel group 10d are arranged around the i second light-emitting elements D2.

For example in FIG. 20, the fourth sub-pixel group 10d comprises four driving circuits 11, four first light-emitting elements D1 and one second light-emitting element D2, and the four first light-emitting elements D1 are arranged around one second light-emitting element D2. Exemplarily, the orthographic projections of the driving circuits 11 and the first light-emitting elements D1 electrically connected to each other in the fourth sub-pixel group 10d on the plane where the display panel is located at least partially overlap, so that the distance between the four driving circuits 11 and the second light-emitting element D2 will not be too far, which can prevent the connection line between the second light-emitting element D2 and the driving circuit 11 from being too long.

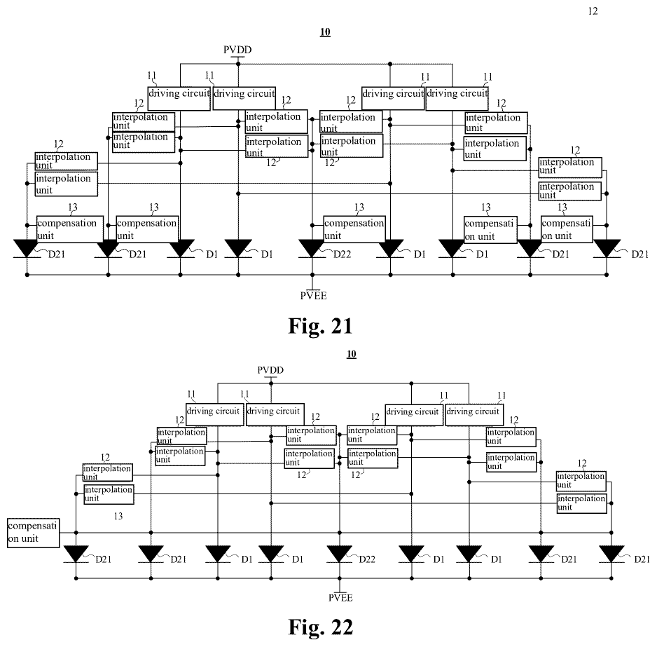

In some embodiments, as shown in FIG. 21, the second light-emitting element comprises a first-type light-emitting element D21 and a second-type light-emitting element D22, the first-type light-emitting element D21 is electrically connected to j driving circuits 11, the second-type light-emitting element D22 is electrically connected to k driving circuits 11, j≠k, j and k are both integers greater than 0, and at least one driving circuit 11 is electrically connected to both the first-type light-emitting element D21 and the second-type light-emitting element D22.

Exemplarily, the first-type light emitting element D21 is electrically connected to the j driving circuits 11 via j interpolation units respectively, and the j interpolation units shunt the driving current output by the j driving circuits 11 respectively, and the shunt currents obtained by the j interpolation units are merged to drive the first-type light emitting element D21. In other words, the first-type light emitting element D21 is driven by the j driving circuits 11 after being interpolated and shunted.

The second-type light emitting element D22 is connected to the k driving circuits 11 via the k interpolation units respectively, and the k interpolation units shunt the driving current output by the k driving circuits 11 respectively, and the shunt currents obtained by the k interpolation units are merged to drive the second-type light emitting element D22. In other words, the second-type light emitting element D22 is driven by the k driving circuits 11 after being interpolated and shunted.

In addition, at least one driving circuit 11 is configured to drive both the first-type light-emitting element D21 and the second-type light-emitting element D22.

In this embodiment, a hybrid interpolation shunt design is adopted, which not only allows fewer driving circuits to drive more second light-emitting elements, but also the number of driving circuits electrically connected to the second-type light-emitting elements is larger, and the shunt obtained by the second-type light-emitting elements can more easily meet their brightness requirements.

As an example, j=2, k=4.

In this example, a sub-pixel group comprises four driving circuits, four first light-emitting elements, one second light-emitting element and four first light-emitting elements. The four driving circuits are configured to drive the nine light-emitting elements, which can not only reduce the number of required driving circuits, but also enable every two driving circuits which have been interpolated to drive one first-type light-emitting element, and enable every four driving circuits which have been interpolated to drive one second-type light-emitting element. Such distribution mode can ensure the luminous effect of each light-emitting element.

Exemplarily, as shown in FIG. 21, the compensation unit 13 and the second light emitting elements may be connected in a one-to-one correspondence. Alternatively, as shown in FIG. 22, the compensation unit 13 is connected to a plurality of second light emitting elements, and the compensation unit 13 compensates the plurality of second light emitting elements.

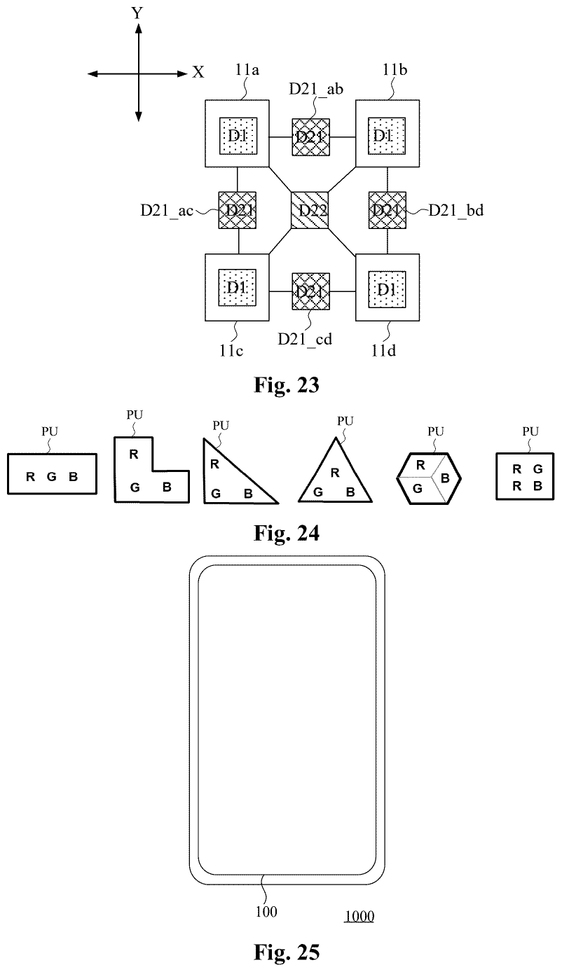

In some embodiments, in the case that j=2 and k=4, as shown in FIG. 23, for example, the first direction X is the row direction, the second direction Y is the column direction, the sub-pixel group comprises four first light-emitting elements D1, four first-type light-emitting elements D21 and one second-type light-emitting element D22, and the light-emitting elements in the sub-pixel group are arranged in 3 rows and 3 columns, and the second-type light-emitting element D22 is located at the center of the sub-pixel group.

Exemplarily, in the first direction X, there is a first light emitting element D1 on each side of the first type light emitting element D21; and in the second direction Y, there is a first light emitting element D1 on each side of the first type light emitting element D21.

The sub-pixel group comprises four driving circuits. For ease of explanation, the four driving circuits are marked as 11a, 11b, 11c, and 11d in FIG. 23, and the four first-type light-emitting elements are marked as D21_ab, D21_ac, D21_bd, and D21_cd. The four driving circuits 11a, 11b, 11c, and 11d are electrically connected to the four first light-emitting elements D1 in a one-to-one correspondence. The driving circuit 11a and the driving circuit 11b are configured to drive the first-type light-emitting element D21_ab, the driving circuit 11a and the driving circuit 11c are configured to drive the first-type light-emitting element D21_ac, the driving circuit 11d and the driving circuit 11b are configured to drive the first-type light-emitting element D21_bd, and the driving circuit 11c and the driving circuit 11d are configured to drive the first-type light-emitting element D21_cd. The four driving circuits 11a, 11b, 11c, and 11d are configured to drive the second-type light-emitting element D22.

It can be understood that the first-type light emitting elements D21_ab, D21_ac, D21_bd, and D21_cd correspond to a binary interpolation design, and the second-type light emitting element D22 corresponds to a quartered interpolation design.

For example, the driving currents generated by the four driving circuits 11a, 11b, 11c, and 11d are Ia, Ib, Ic, and Id, respectively. Half of the current of each driving circuit is shunted through interpolation of the first-type light-emitting element, and one quarter of the current of each driving circuit is shunted through interpolation of the second-type light-emitting element. Then, the current obtained by the first-type light-emitting element D21_ab from the driving circuit is (Ia+Ib)/2, the current obtained by the first-type light-emitting element D21_ac from the driving circuit is (Ia+Ic)/2, the current obtained by the first-type light-emitting element D21_bd from the driving circuit is (Ib+Id)/2, the current obtained by the first-type light-emitting element D21_cd from the driving circuit is (Ic+Id)/2, and the current obtained by the second-type light-emitting element D22 from the driving circuit is (Ia+Ib+Ic+Id)/4.

It should be noted that one half and one quarter in this example are merely exemplary descriptions, and the current obtained by each second light-emitting element from the driving circuit can be set according to actual needs.

The interpolation unit and the compensation unit are not shown in FIGS. 18 to 20 and 23, this does not mean that the sub-pixel group does not comprise the interpolation unit and the compensation unit.

In some embodiments, the light emitting elements of multiple light emitting colors in the display panel constitute pixel units. The shape of the orthographic projection of the pixel unit on the plane where the display panel is located comprises any one of the following: triangle, trapezoid, prism, pentagon, hexagon, rectangle, square, or “L” shape.

As shown in FIG. 24, the display panel comprises a red light-emitting element R, a green light-emitting element G and a blue light-emitting element B. The red light-emitting element R, the green light-emitting element G and the blue light-emitting element B constitute a pixel unit PU. The shape of the orthographic projection of the pixel unit PU on the plane where the display panel is located can be a triangle, a trapezoid, a prism, a pentagon, a hexagon, a rectangle, a square, an “L” shape, etc., so that more pixel units can be accommodated to improve the PPI.

For example, if better display effects are sought, four light-emitting elements (eg, R/R/G/B) are arranged in one pixel to enrich the display colors and improve the color gamut.

The present application also provides a display device, including the display panel provided in the present application. Reference is made to FIG. 25, which is a schematic structural diagram of a display device provided in an embodiment of the present application. The display device 1000 provided in FIG. 25 comprises a display panel 100 provided in any of the above embodiments of the present application. The embodiment of FIG. 25 only takes a mobile phone as an example to illustrate the display device 1000. It can be understood that the display device provided in the embodiment of the present application can be a wearable product, a computer, a television, a car display device, or other display devices with display functions, and the present application does not make specific restrictions on this. The display device provided in the embodiment of the present application has the beneficial effects of the display panel provided in the embodiment of the present application. Details can be referred to the specific description of the display panel in the above embodiments, which will not be repeated here.

According to the embodiments described above in the present application, these embodiments do not describe all the details in detail, nor do they limit the present application to the specific embodiments described. Obviously, many modifications and changes can be made based on the above description. This specification selects and specifically describes these embodiments in order to better explain the principles and practical applications of the present application, so that those skilled in the art can make good use of the present application and the modifications based on the present application. The present application is limited only by the claims and their full scope and equivalents.

What is claimed is:

1. A display panel, comprising a sub-pixel group that comprises n driving circuits and m light-emitting elements, output ends of the n driving circuits being electrically connected to the m light-emitting elements, wherein
the m light-emitting elements comprise n first light-emitting elements and i second light-emitting elements, output ends of the n driving circuits being electrically connected to the n first light-emitting elements in a one-to-one correspondence, and an output end of at least one of the n driving circuits being electrically connected to at least one of the i second light-emitting elements via an interpolation unit, the i second light-emitting elements each being electrically connected to a compensation unit, where n+i=m, and m, n, i are all integers greater than 0; and
the interpolation unit is configured to transmit a driving signal from the driving circuit to the second light-emitting element, and the compensation unit is configured to compensate the second light-emitting element with a driving signal.

2. The display panel according to claim 1, wherein i≥n.

3. The display panel according to claim 2, wherein an output end of at least one of the driving circuits is electrically connected to a plurality of the second light-emitting elements via one of the interpolation units;
or, at least two of the second light-emitting elements are electrically connected to an output end of one of the driving circuits via different ones of the interpolation units respectively.

4. The display panel according to claim 1, wherein i<n.

5. The display panel according to claim 4, wherein at least one of the second light-emitting elements is electrically connected to output ends of different ones of the driving circuits via different ones of the interpolation units.

6. The display panel according to claim 2, wherein at least one of the compensation units is electrically connected to a plurality of the second light-emitting elements;
or, at least two of the second light-emitting elements are each electrically connected to different ones of the compensation units.

7. The display panel according to claim 1, wherein the interpolation unit comprises a first transistor, a first electrode of the first transistor being electrically connected to the output end of the driving circuit, a second electrode of the first transistor being electrically connected to the second light-emitting element, and a gate of the first transistor being connected to a first control signal.

8. The display panel according to claim 7, wherein the first control signal is the same as a light emitting control signal connected to the driving circuit;
or, the first control signal is different from the light emitting control signal connected to the driving circuit.

9. The display panel according to claim 1, wherein the compensation unit comprises a resistor, an end of the resistor being electrically connected to a compensation voltage end, and the other end of the resistor being electrically connected to the second light emitting element.

10. The display panel according to claim 9, wherein at least one of the resistance value of the resistor or the voltage value of the compensation voltage end is adjustable.

11. The display panel according to claim 10, wherein in the case that the second light emitting element does not need to be compensated, the resistance value of the resistor is infinite, and/or the compensation voltage end does not output voltage.

12. The display panel according to claim 1, wherein the display panel comprises a plurality of the sub-pixel groups, and the connection relationship between the driving circuits and the light-emitting elements in each of the sub-pixel groups is the same.

13. The display panel according to claim 1, wherein the sub-pixel group comprises at least a first sub-pixel group and a second sub-pixel group, and the connection relationship between the driving circuits and the light-emitting elements in the first sub-pixel group is different from the connection relationship between the driving circuits and the light-emitting elements in the second sub-pixel group.

14. The display panel according to claim 13, wherein the number of the first light-emitting elements in the first sub-pixel group is different from the number of the first light-emitting elements in the second sub-pixel group, and/or the number of the second light-emitting elements in the first sub-pixel group is different from the number of the second light-emitting elements in the second sub-pixel group, and/or the number of the interpolation units in the first sub-pixel group is different from the number of the interpolation units in the second sub-pixel group, and/or the number of the compensation units in the first sub-pixel group is different from the number of the compensation units in the second sub-pixel group.

15. The display panel according to claim 1, wherein the sub-pixel group comprises a third sub-pixel group, in which i≥n, and the i second light-emitting elements in the third sub-pixel group are arranged around the n first light-emitting elements;
and/or, the sub-pixel group comprises a fourth sub-pixel group, in which n>i, and the n first light-emitting elements in the fourth sub-pixel group are arranged around the i second light-emitting elements.

16. The display panel according to claim 1, wherein the second light-emitting elements comprise first-type light-emitting elements and second-type light-emitting elements, the first-type light-emitting elements being electrically connected to j ones of the driving circuits, the second-type light-emitting elements being electrically connected to k ones of the driving circuits, where j≠k, and j and k are both integers greater than 0, and at least one of the driving circuits is electrically connected to at least one of the first-type light-emitting elements and at least one of the second-type light-emitting elements simultaneously.

17. The display panel according to claim 16, wherein j=2, k=4.

18. The display panel according to claim 17, wherein the sub-pixel group comprises four said first light-emitting elements, four said first-type light-emitting elements and one said second-type light-emitting element, the light-emitting elements in the sub-pixel group are arranged in 3 rows and 3 columns, and the second-type light-emitting element is located at a center of the sub-pixel group.

19. The display panel according to claim 1, wherein the output ends of the driving circuits are electrically connected to the first light emitting elements via third transistors;
a refresh frame of the display panel comprises at least a first sub-frame and a second sub-frame;
in the first sub-frame, the third transistors are turned on and the interpolation units are turned off;
in the second sub-frame, the third transistors are turned off and the interpolation units are turned on.

20. A display device, comprising the display panel, comprising a sub-pixel group that comprises n driving circuits and m light-emitting elements, output ends of the n driving circuits being electrically connected to the m light-emitting elements, wherein
the m light-emitting elements comprise n first light-emitting elements and i second light-emitting elements, output ends of the n driving circuits being electrically connected to the n first light-emitting elements in a one-to-one correspondence, and an output end of at least one of the n driving circuits being electrically connected to at least one of the i second light-emitting elements via an interpolation unit, the i second light-emitting elements each being electrically connected to a compensation unit, where n+i=m, and m, n, i are all integers greater than 0; and
the interpolation unit is configured to transmit a driving signal from the driving circuit to the second light-emitting element, and the compensation unit is configured to compensate the second light-emitting element with a driving signal.
